(19) United States
(12) Patent Application Publication
(10) Pub. No.: US 2003/0046656 A1
(43) Pub. Date: Mar. 6, 2003

(54) Information technology outsourcing hubs

(76) Inventor: Asha Saxena, Colonia, NJ (US)

Correspondence Address: Mr. Walter J. Tencza Jr., Suite 3, 10 Station Place, Metuchen, NJ, 08840, US

(21) Appl. No.: 10/230,696

(22) Filed: Aug. 29, 2002

(51) Int. Cl. G06F 9/44; G06F 17/60

(52) U.S. Cl. 717/101; 705/1

(57) ABSTRACT

A method is disclosed comprising providing a plurality of information technology hubs, each information technology hub located at one of a plurality of geographic locations, each information technology hub located at a geographic location different from the other information technology hubs. Each of the information technology hubs provides computer system support to a plurality of clients within a geographic area. Each of the information technology hubs may provide twenty-four hours a day and seven days a week of computer systems support for each of its plurality of clients.

### FIELD OF THE INVENTION

This invention relates to improved methods and apparatus concerning ways of providing information technology services.

### BACKGROUND OF THE INVENTION

Typically in the past, business entities have had their own information technology departments for maintaining their computers and computer networks. The cost of information technology departments can be exorbitant and as the business expands and the capabilities of many in house technology departments becomes overtaxed, businesses face cost overruns, missed deadlines and delays which have negative consequences on business growth. Although some larger businesses have found outsourcing of these services advantageous, many smaller firms (under $500 million dollars/year gross) have no alternatives for outsourcing since the largest providers typically focus on the larger accounts. If a smaller business is lucky enough to contract with a provider, they very often are faced with a provider who can't provide a full scope of services or one who can't grow at the same pace with the smaller business as it takes on further business.

A small business supporting their own computer website may have to invest in technology management skills to outline the requirements of the site, website development skills to create and test the site and another set of skills to maintain the technical environment once the website is implemented.

### SUMMARY OF THE INVENTION

The present invention in one or more embodiments supplies information technology hubs to regions throughout the country which when tied together can provide full functional computer system services to clients while taking advantage of economies-of-scale provided by the hubs. Each information technology hub focuses on clients within a geographic region and each hub typically offers a full range of services including but not limited to business consulting, information technology (“IT”) management consulting, on-site staffing/management, project development and testing, website design and operation, implementation services, full twenty-four hours a day, seven days a week, system maintenance, help desk, telecommunications, server support and operations. Each hub will customize its service offerings to the clients and over time build a full range of service offerings to its clients. As regional Hubs become saturated or as each member client grows, then each hub will grow based upon their unique client demands. Information technology hubs may also be consolidated into larger service centers when they hit financial, staffing or technology limitations.

### BRIEF DESCRIPTION OF THE DRAWINGS

FIG. 1 shows a block diagram of an information technology outsourcing business method, system, and apparatus in accordance with a first embodiment of the present invention; and

FIG. 2 shows a diagram of several information technology hubs and their locations.

### DETAILED DESCRIPTION OF THE DRAWINGS

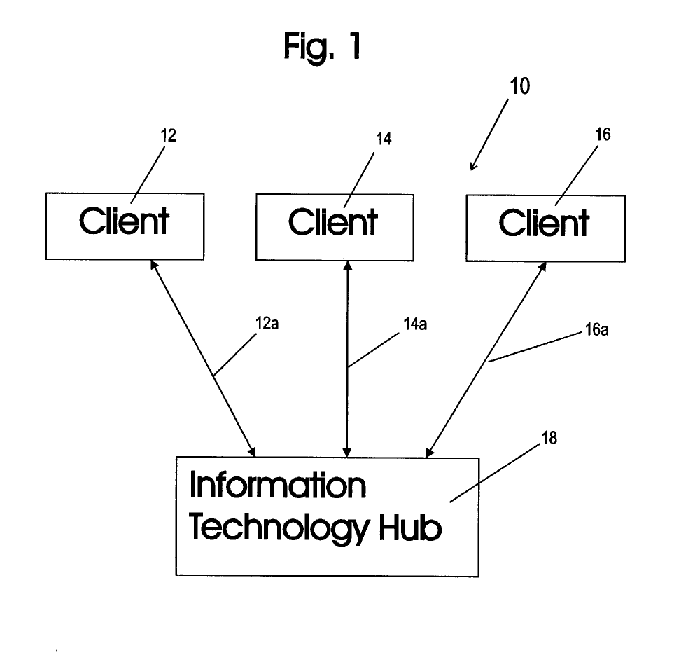

FIG. 1 shows a block diagram 10 of an information technology outsourcing business method, system, and apparatus in accordance with a first embodiment of the present invention. The diagram 10 shows a client 12, a client 14, and a client 16. The clients 12, 14, and 16 are linked to an information technology hub 18 by links 12a, 14a, and 16a. Each of the clients 12, 14, and 16 may be a business entity such as a corporation, partnership, sole proprietorship, non-profit organization or any type of business entity. The clients 12, 14, and 16 may each be in different core businesses. For example client 12 may be a pharmaceutical manufacturer, client 14 may be a food store, and client 16 may be a law firm.

Each of the clients 12, 14, and 16 has one or more computers, which may be linked together by one or more computer networks. In accordance with an aspect of one embodiment of the present invention, the information technology hub 18 maintains the computers and/or computer networks of each of the clients 12, 14, and 16.

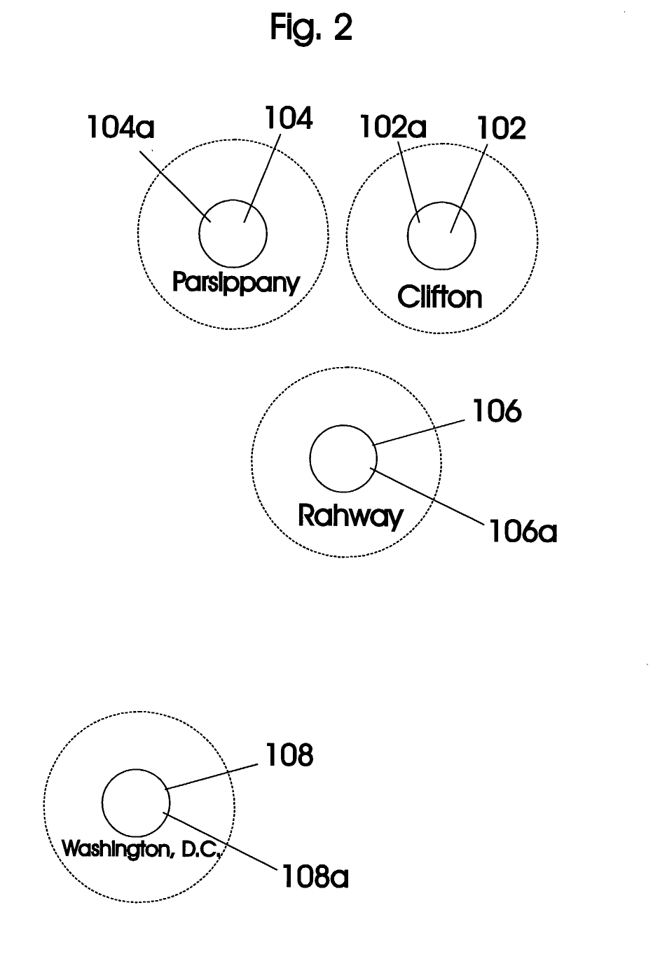

FIG. 2 shows a diagram 100 of possible locations 102, 104, 106, and 108 of information technology hubs 102a, 104a, 106a, and 108a, respectively, in accordance with one or more embodiments of the present invention. Location 102 is shown as a region near Clifton, N.J. Location 104 is shown as a region near Parsippany, N.J. Location 106 is shown as a region near Rahway, N.J. Location 108 is shown as a region near Washington, D.C. Each of the hubs 102a, 104a, 106a, and 108a may be similar to information technology hub 18 in FIG. 1 and each of the hubs 102a, 104, 106a, and 108a may link or interact with a plurality of clients in a specific geographic vicinity. Each hub of hubs 102a, 104a, 106a, and 108a may be a center for excellence in information technology. Each hub may provide website development and twenty-four hours a day and seven days a week support for each client. Each of hubs 102a, 104a, 106a, and 108a may provide control of a computer network for one or more clients, a server farm (a “server farm” can be defined as a location where several servers will be hosted), a computer systems infrastructure management, and data relationship practices services. Each of the hubs 102a, 104a, 106a, and 108a may interact with offshore development and testing entities such as entities outside the United States, for developing and testing of, for example, computer software and/or computer systems.

The present invention in various embodiments will rely on the method of operation to utilize the Centers of Excellence or information technology hubs 102a, 104a, 106a, and 108a to provide web site development services and other services to each client at a reduced risk and cost, since people with similar skills staff the Centers of Excellence so instead of supporting only one client's needs, they can support the needs of many. For example, each hub 102a, 104a, 106a, and 108a may have a computer server maintenance staff person who will provide the same computer server maintenance service to the each of the computer servers of a plurality of clients since the skills required for each client may be, in this example, identical.

The present invention in one or more embodiments provides technology outsourcing to business entities using Centers of Excellence, or information technology hubs, such as hubs 102a, 104a, 106a, and 108a. Specifically each of hubs 102a, 104a, 106a, and 108a focuses on clients within its geographic region and offers a full range of support services including but not limited to business consulting, information technology (“IT”) management consulting, on-site staffing/management, project development and testing, website design and operation, implementation services, full twenty-four hours a day, seven days a week, system maintenance, help desk, telecommunications, server support and operations. Each hub will customize its service offerings to the clients and over time build a full range of service offerings to its clients. The common client technical requirements can be identified and where possible satisfied using a standard set of offerings. An example of a standard set of offerings could be the maintenance of Microsoft (trademarked) products which would be the same for a plurality of clients. Therefore the same resources could be utilized by various clients. The methodologies can be developed for these clients to service them. It is the inventor's experience that 75% of a client's information technology needs such as computer or computer systems support, are common to other clients and the methods of the present invention allow the information technology hubs such as hub 102a, 104a, 106a, and 108a to then provide these services by sharing the staff and resources of each hub 102a, 104a, 106a, and 108a. Each client receives services at a reduced cost with reduced risk. As regional hubs, such as hubs 102a, 104a, 106a, and 108a become saturated or as each member client grows, then each hub can grow based upon their unique client demands. Hubs may also be consolidated into larger service centers when they hit financial, staffing or technology limitations.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising the steps of:
providing a plurality of information technology hubs, each information technology hub located at one of a plurality of geographic locations, each information technology hub located at a geographic location different from the other information technology hubs; and
wherein each of the information technology hubs provides computer system support to a plurality of clients within a geographic area.

2. The method of claim 1 wherein
each of the information technology hubs provides twenty-four hours a day and seven days a week of computer systems support for each of its plurality of clients.

3. The method of claim 1 wherein
each of the information technology hubs provides control of a computer network for one or more of its plurality of clients.

4. The method of claim 1 wherein
each of the information technology hubs provides computer systems infrastructure management for one or more of its plurality of clients.

5. The method of claim 1 wherein
each of the information technology hubs provides data relationship practices services for one or more of its plurality of clients.

6. The method of claim 1 wherein
each of the information technology hubs interacts with offshore development and testing entities for developing and testing computer systems for one or more of its plurality of clients.

7. The method of claim 1 wherein
each of the information technology hubs provides web site development services to one or more of its plurality of clients.
